(19) United States
(12) Patent Application Publication
(10) Pub. No.: US 2013/0132395 A1
(43) Pub. Date: May 23, 2013

(54) MOBILE SOCIAL GROUPS

(71) Applicant: Arpit Gupta, Santa Clara, CA (US)

(72) Inventor: Arpit Gupta, Santa Clara, CA (US)

(73) Assignee: Yahoo! Inc., Sunnyvale, CA (US)

(21) Appl. No.: 13/303,639

(22) Filed: Nov. 23, 2011

(51) Int. Cl. G06F 17/30

(52) U.S. Cl. 707/740; 707/748; 707/E17.058; 707/E17.032

(57) ABSTRACT

Expanding a user's social connections to include mobile contacts includes: receiving a user's call logs for call/text transactions from a mobile device; deriving usage information from the call logs to determine social pairs; ranking the social pairs based on strength of connectedness; and merging the ranked social pairs with the user's contacts from on-line social networks.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of social networks, and more particularly relates to the field of social connections through mobile devices.

### BACKGROUND OF THE INVENTION

Mobile devices have shown tremendous growth with respect to computers. Recent statistics reveal that in many countries, the number of cell phones in use outnumbers the total population. Most young people use their mobile phones as their primary mode of communication, with voice and text.

However, current social networking technologies seem to ignore the social patterns among mobile phone users, instead assuming that everyone in a social network has Internet and computer access.

### SUMMARY OF THE INVENTION

Briefly, according to an embodiment of the invention a method for expanding a user's social connections to include mobile contacts includes steps or acts of: receiving a user's call logs for call/text transactions from a mobile device; deriving usage information from the call logs to determine social pairs; ranking the social pairs based on strength of connectedness; and merging the ranked social pairs with the user's contacts from on-line social networks.

According to another embodiment of the present invention, a computer readable storage medium includes program instructions for performing the method steps above.

According to another embodiment of the present invention, an information processing system includes memory with program instructions stored therein, the program instructions causing a computer to perform: receiving a user's call logs for call/text transactions from a mobile device; deriving usage information from the call logs to determine social pairs; ranking the social pairs based on strength of connectedness; and merging the ranked social pairs with the user's contacts from on-line social networks. The system further includes a processor device operably coupled with the memory for executing the program instructions.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of the social mobile network platform, according to an embodiment of the present invention;

FIG. 2 is a flowchart of a method according to an embodiment of the invention;

FIG. 3 is a simplified block diagram of a computing system configured to operate according to an embodiment of the present invention;

FIG. 4 shows a simplified representation of a call/text log for a user for one day;

FIG. 5 shows a simplified representation of a log with matched number/name pairs, according to an embodiment of the present invention;

FIG. 6 shows a flowchart of a subprocess from the flowchart of FIG. 2, according to an embodiment of the present invention;

FIG. 7 shows a flowchart of the merge subprocess, according to an embodiment of the present invention; and

FIG. 8 shows how the social graph, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We discuss a social network platform based on mobile telephone communication. The need for this is clear. The social links that people make by phone are not represented in their on-line social networks. The advantage of the mobile social network as will be described herein does not require the user to create new on-line accesses or to maintain an Internet connection. We establish a meaningful social network platform based on a user's mobile usage patterns, such as the calls/texts made to specific numbers and the numbers added by the user, as well as the frequency of the calls/texts and the length of time spent on each call/text. Presumably, the phone contacts with whom the user is communicating on a regular basis are his/her social network as much as, and maybe more than, the user's on-line social network contacts (such as Facebook and Twitter).

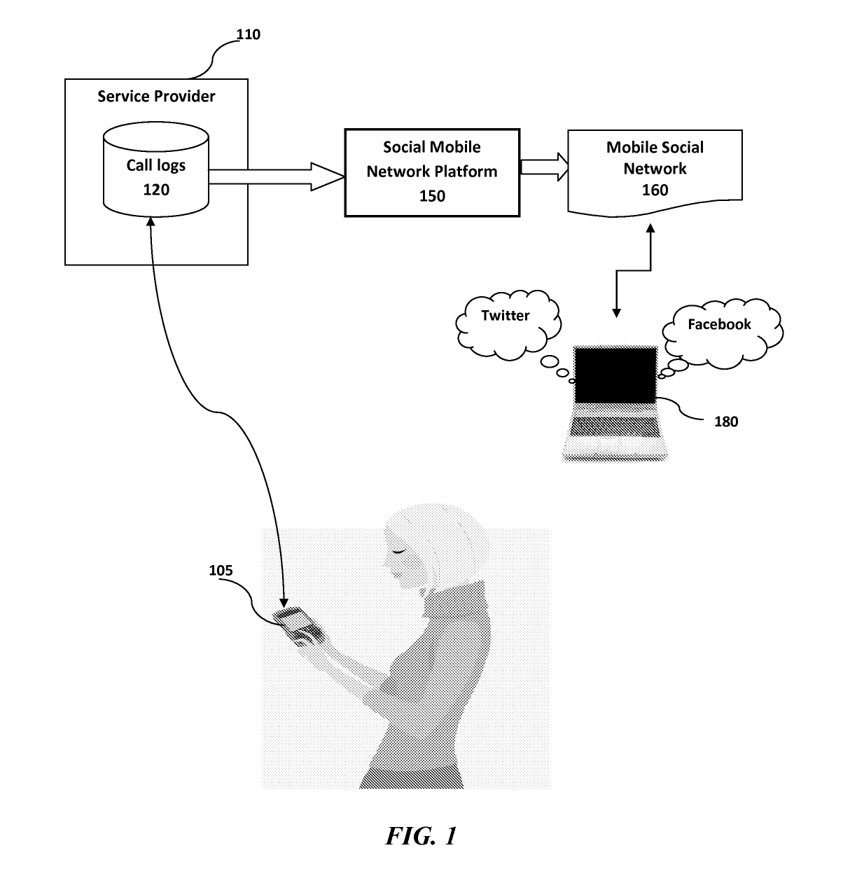

Referring now to the drawings and to FIG. 1 in particular, we show a simplified illustration of the implementation of the social mobile network platform 150, according to an embodiment of the present invention. The social mobile network platform 150 collects usage information for the data and voice calls received and initiated by the user via the user's mobile device 105. This information is available from the service provider 110 as a call log 120. The service provider 110 maintains the logs 120 of all incoming and outgoing call/text transactions and this information is used by the platform 150 to derive a mobile social network 160.

The mobile social network 160 assigns a status ranking ranging from most-connected to least-connected social pairs based on: a) the number of transactions; and b) the duration of each transaction. We define a social pair as the “user+x,” with x being either the initiator or the receiver of each call/text. As the history for particular social pairs builds, the originally derived connections become stronger compared to others. Conversely, some social pairs will lose their connected status over a period of time as less contact is made between them. We also assign a higher priority to cell phone transactions initiated by the primary user. Those transactions received by the primary user are accorded a lower priority.

Once we have defined the social pairs, we aggregate them into groups by category. To define the categories we use parameters such as voice only, data only, (SMS, MMS, etc) or mixed (voice and data). Additionally, we look at temporal parameters, such as time of day (morning, evening); and specific day as for recurring conference calls. The strength of connections will be determined with the parameters including number of transactions, frequency of the transactions, initiated transactions versus received transactions, duration of transactions, and recency of transactions. Then, we merge the new social connections from the mobile social network 160 with the user's existing social network accounts 180. By uncovering these new social connections 160 based on mobile usage patterns and merging them with other social networks 180 we are able to enrich the user's Internet-based social networks 180 and the user's profile.

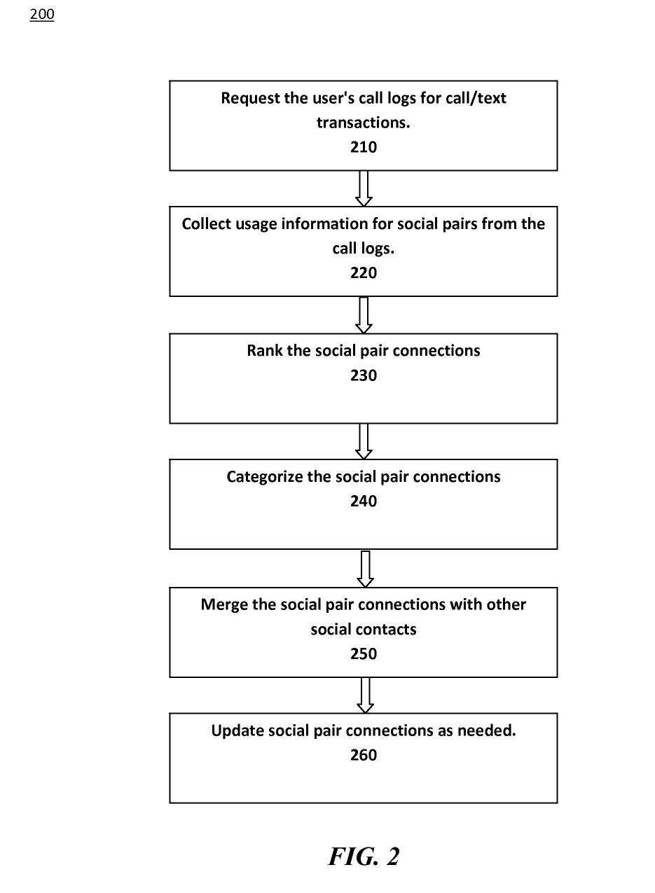

Referring now to FIG. 2, we show a flowchart 200 of the implementation of the mobile social network platform 150, according to an embodiment of the present invention. We begin at step 210 by requesting the user's call logs 120 for the user's call/text transactions. The telephone network service provider 110 maintains the logs 120 of all of the user's call/text transactions. Once we are granted access to the call logs 120, in step 220 we collect the usage information over time in order to derive the social pairs to produce a social graph. Note that we do not consider every call/text transaction from the call logs for inclusion as a social pair. We need to eliminate those transactions that do not meet a pre-determined social threshold. We eliminate: a) calls/text to/from a business/government; b) calls/text that only occur once; and c) calls of a very short duration (probable wrong number).

Then we rank the social pairs by the strength of their “connectedness” in step 230. We assign a status ranging from most-connected to least-connected social pairs based on: a) the number of transactions; and b) the duration of each transaction. We assign a higher priority to cell phone transactions initiated by the primary user as compared to those transactions received by the primary user.

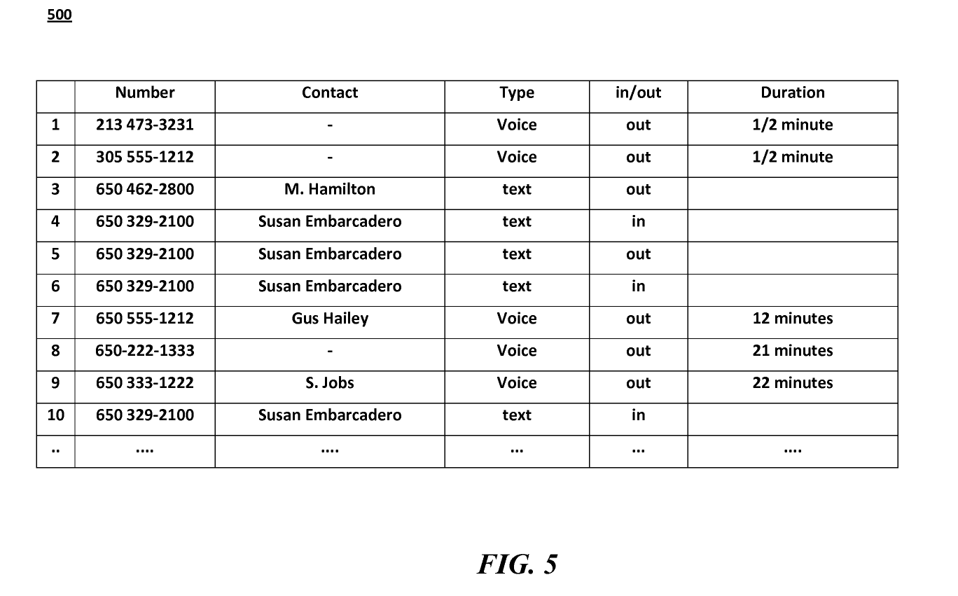

In step 240 we aggregate the social pairs into groups by category. We use parameters such as voice only, data only (SMS, MMS, etc) or mixed (voice and data). Additionally, we look at temporal parameters, such as time of day (morning, evening); and specific day as for recurring conference calls. FIG. 5 shows a log with matched social pairs. The strength of connections will be determined with the parameters including number of transactions, frequency of the transactions, initiated transactions versus received transactions, duration of transactions, and recency of transactions.

Then, in step 250 we merge the new social connections from the mobile social network 160 with the user's existing social network accounts 180. By uncovering these new social connections 160 based on mobile usage and integrating them with the user's profile and with other social networks 180 we are able to enrich the user's Internet-based social networks 180.

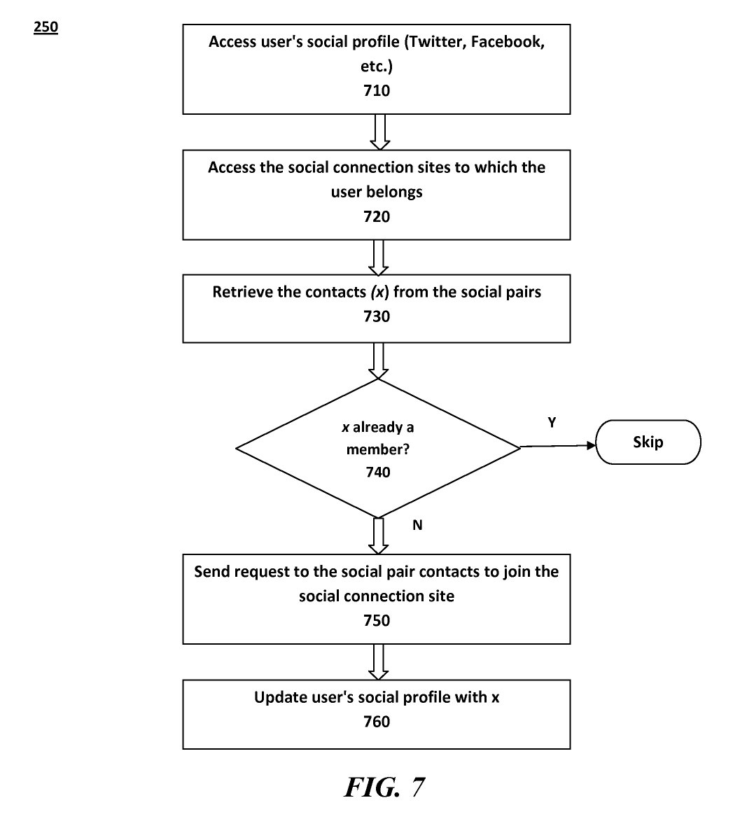

FIG. 7 shows the sub-process steps for step 250. We access the user's social profile in step 710 to be able to view the social contacts the user has designated in his/her on-line social networking sites. Then we access the particular social connection sites 180 to which the user belongs (Facebook, Twitter) in step 720. We retrieve our stored mobile call/text contacts (x). If x is already a member of the social connection site, as determined in step 740, we skip the rest of the sub-process steps. If not, the platform sends the connection requests to the mobile call/text contacts (x) through the on-line social networks 180 in step 750. We ask them to join the user's social connection site. In step 760 we add x to the user's social profile. In this way, when a user logs in to his/her social network 180 over the Internet, the user's mobile social connections 160 will be included.

Over time, we will need to update the ranking in step 260. As the history for particular users builds, the originally derived connections become stronger compared to others. Some social pairs will lose their connected status over a period of time as less contact is made between them. The connections need to be pruned constantly to check for recency, activity and current status.

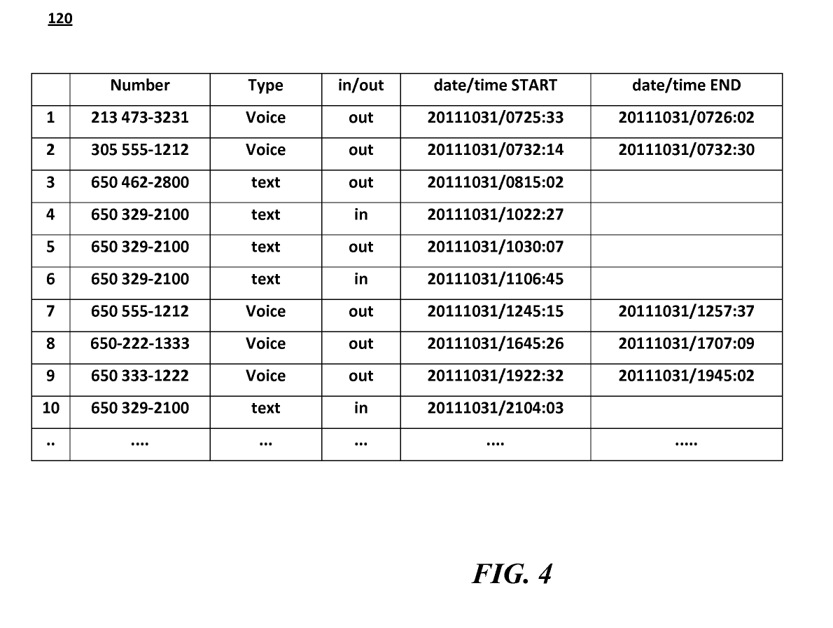

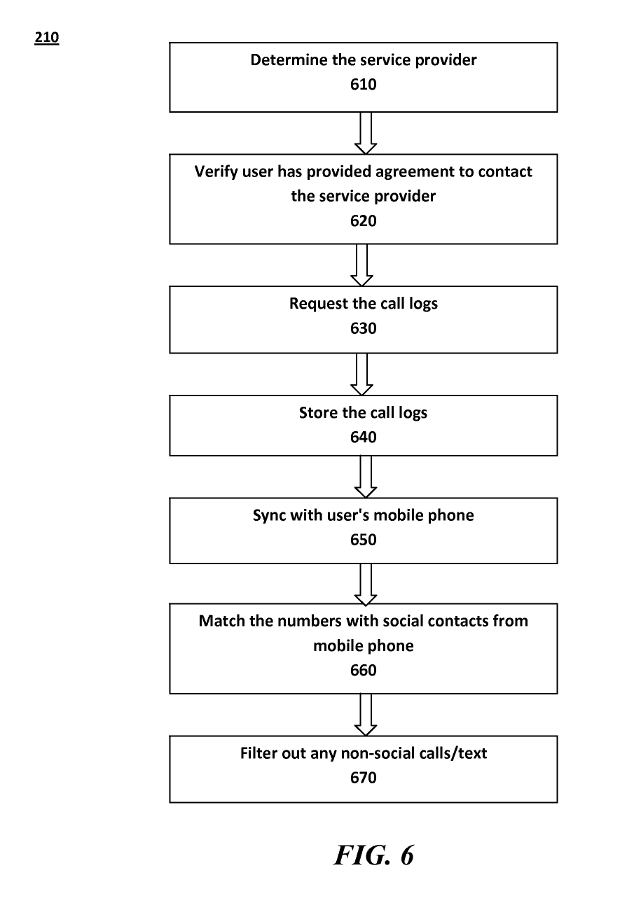

Referring now to FIG. 6 we show the sub-process steps for step 210 of FIG. 2. First we need to determine the user's service provider in step 610. In order to acquire access to the call logs 120, the users must first opt in for the mobile social groups service and provide a release. In step 620 we verify that the user has provided permission to contact his/her service provider 110. Since agreements of this nature tend to have temporal limits, we must monitor expiration dates and renew accordingly. Once accepted into the service, our platform 150 will work directly with the user's service provider 110 to obtain the user translations (call logs 120) in step 630. In step 640 we store the call logs 120. Now we have call logs 120 which provide telephone numbers, but no names. See FIG. 4 for an exemplary representation of a call log 120 for a user representing calls/texts made/received in one day.

We need to match the phone numbers from the call logs 120 with their names. In order to accomplish this, we sync with the user's mobile device 105 where the user has stored his/her phone contacts with name and contact details in step 650. In step 660 we match the phone numbers from the call logs 120 to the contact names from the user's mobile device 105 in step 660. We add the names and details to the social graph we maintain in our platform 150.

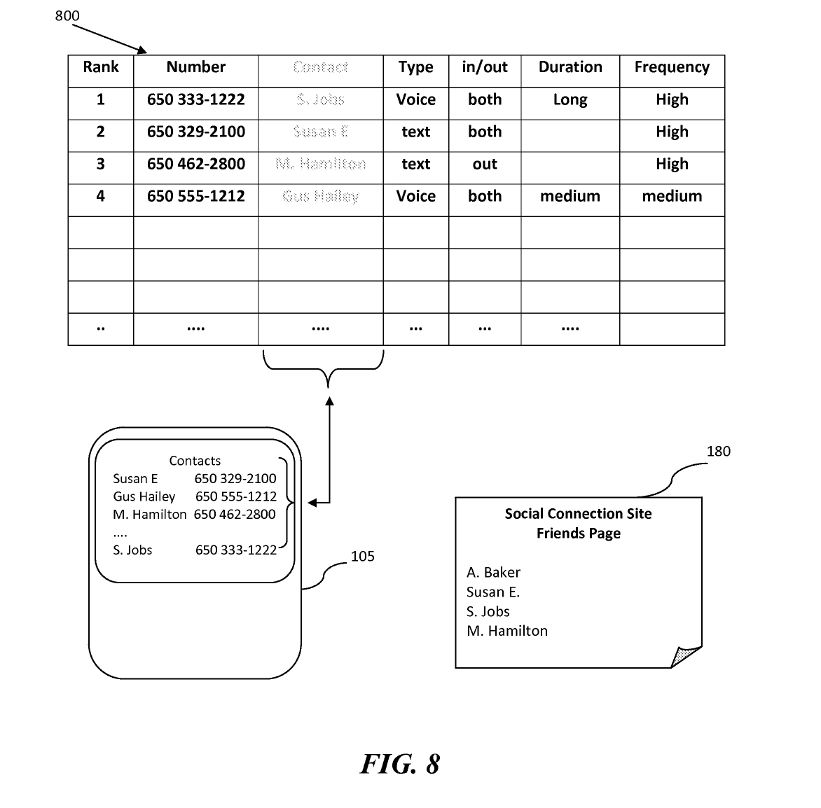

FIG. 8 shows an exemplary social graph 800. Here you can see that calls/texts pertaining to businesses/government and calls/texts of a very short duration have been eliminated. We assigned a ranking based on frequency, recency, duration, and origin of the calls/texts. Based on this ranking, we determined the “most-connected”social pairs, and here the top four are shown. From this grouping of “most-connected” we implemented the sub-process shown in FIG. 6 to derive the contact names (shown grayed out) from the user's mobile device 105. Then, with the contact names we implemented the sub-process of FIG. 7 to merge these “most-connected” social pairings with the user's social networking contacts from social networking sites 180. Here we show that Susan E., S. Jobs, and M. Hamilton are already “friends” on the site 180, so we send a connection request to Gus Hailey only.

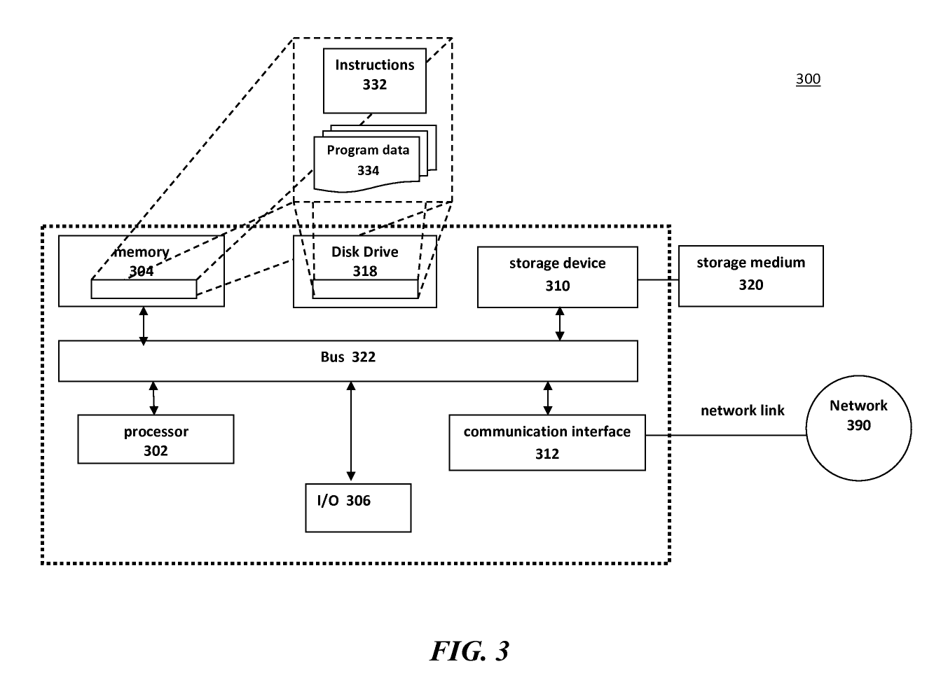

FIG. 3 System Embodiment.

Referring now to FIG. 3, there is provided a simplified pictorial illustration of an information processing system 300 for the social mobile network platform 150 in which the present invention may be implemented. The exemplary embodiment is only one example of suitable components and is not intended to suggest any limitation as to the scope of use or functionality of the invention. For purposes of this invention, computer system 300 may represent any type of computer, information processing system or other programmable electronic device, including a client computer, a server computer, a portable computer, an embedded controller, a personal digital assistant, and so on. The computer system 300 may be a stand-alone device or networked into a larger system. Computer system 300, illustrated for exemplary purposes as a networked computing device, is in communication with other networked computing devices (not shown) via network 310. As will be appreciated by those of ordinary skill in the art, network 310 may be embodied using conventional networking technologies and may include one or more of the following: local area networks, wide area networks, intranets, public Internet and the like.

Throughout the description herein, an embodiment of the invention is illustrated with aspects of the invention embodied solely on computer system 300. As will be appreciated by those of ordinary skill in the art, aspects of the invention may be distributed amongst one or more networked computing devices which interact with computer system 300 via one or more data networks such as, for example, network 310. However, for ease of understanding, aspects of the invention have been embodied in a single computing device—computer system 300.

Computer system 300 includes inter alia processing device 302 which communicates with an input/output subsystem 306, memory 304, storage 310 and network 310. The processor device 302 is operably coupled with a communication infrastructure 322 (e.g., a communications bus, cross-over bar, or network). The processor device 302 may be a general or special purpose microprocessor operating under control of computer program instructions executed from memory 304 on program data 334. The program data 334 includes the objects and their metadata. Program instructions for generating the mobile social pairs and merging them with social networks may be stored in 332. The processor 302 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 304 may be partitioned or otherwise mapped to reflect the boundaries of the various memory subcomponents. Memory 304 may include both volatile and persistent memory for the storage of: operational instructions 332 for execution by CPU 102, data registers, application storage and the like. Memory 304 preferably includes a combination of random access memory (RAM), read only memory (ROM) and persistent memory such as that provided by a hard disk drive 318. The computer instructions/applications that are stored in memory 304 are executed by processor 302. The computer instructions/applications 332 and program data 334 can also be stored in hard disk drive 318 for execution by processor device 302.

The I/O subsystem 306 may comprise various end user interfaces such as a display, a keyboards, and a mouse. The I/O subsystem 306 may further comprise a connection to a network 390 such as a local-area network (LAN) or wide-area network (WAN) such as the Internet.

The computer system 300 may also include a removable storage drive 310, representing a floppy disk drive, a magnetic tape drive, an optical disk drive, etc. The removable storage drive 310 reads from and/or writes to a removable storage unit 320 in a manner well known to those having ordinary skill in the art. Removable storage unit 320, represents a floppy disk, a compact disc, magnetic tape, optical disk, CD-ROM, DVD-ROM, etc. which is read by and written to by removable storage drive 310. As will be appreciated, the removable storage unit 320 includes a non-transitory computer readable medium having stored therein computer software and/or data.

The computer system 300 may also include a communications interface 312. Communications interface 312 allows software and data to be transferred between the computer system and external devices. Examples of communications interface 312 may include a modem, a network interface (such as an Ethernet card), a communications port, a PCMCIA slot and card, etc. Software and data transferred via communications interface 312 are in the form of signals which may be, for example, electronic, electromagnetic, optical, or other signals capable of being received by communications interface 312.

In this document, the terms “computer program medium,” “computer usable medium,” and “computer readable medium” are used to generally refer to both transitory and non-transitory media such as main memory 304, removable storage drive 320, a hard disk installed in hard disk drive 318, and signals. These computer program products are means for providing software to the computer system 300. The computer readable medium 320 allows the computer system 300 to read data, instructions, messages or message packets, and other computer readable information from the computer readable medium 320.

Benefits and Advantages of the Invention.

We are able to bring new users to the social graph by connecting the mobile users with the user's already existing social networks. This can be applied to mobiles without internet connectivity as well as the smart phones to uncover new links based on activity/transactions. In addition, we are able to use the social pair ranking and categories to target advertisements based on the strength of the call/text connections, time of day, and what the network as a whole is doing. Uncovering new connections from random phone calls. Collaboration of offline and online social networks. Targeted Ads based on strength of connections and recency, group activity. Cross pollination of Ads on and off network.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for expanding a user's social connections with mobile contacts, comprising steps of:
receiving a user's call logs with call/text transactions for a mobile device;
deriving usage information from the call logs to determine social pairs, wherein a social pair comprises the user plus a call/text social partner;
ranking the social pairs based on strength of connectedness to generate a social graph; and
merging the ranked social pairs with the user's contacts from on-line social networks.

2. The method of claim 1 further comprising:
grouping the social pairs by category in the social graph.

3. The method of claim 2 wherein the grouping comprises grouping by at least one of:
type of transaction, time of day, and recurrence.

4. The method of claim 1 further comprising updating the social graph.

5. The method of claim 1 wherein deriving the usage information comprises eliminating the call/text transactions to/from a business.

6. The method of claim 1 wherein receiving the user's call logs comprises steps of:
determining the service provider;
verifying that the user has provided permission to access the call logs; and
requesting the call logs from the service provider.

7. The method of claim 6 further comprising steps of:
syncing with the mobile device;
searching contacts in the mobile device; and
matching numbers from the call logs to the contacts in the mobile device.

8. The method of claim 1 wherein merging the ranked social pairs comprises steps of:
viewing social connection sites to which the user belongs;
determining if any of the call/text social partners are already members of the social connection sites;
sending a request to the call/text social partner to join the user's social connection site when it is determined that the call/text social partner is not already a member; and
updating the user's social profile when the call/text social partner joins the user's social connection site.

9. An information processing system for expanding a user's social connections to include mobile contacts, comprising:
a memory with computer-executable instructions stored therein, said instructions causing a computer to perform:
receiving a user's call logs with all call/text transactions for a mobile device;
deriving usage information from the call logs to determine social pairs, wherein a social pair comprises the user plus a call/text social partner;
ranking the social pairs based on strength of connectedness to generate a social graph; and
merging the ranked social pairs with the user's contacts from on-line social networks; and
a processor device operably coupled with the memory, said processor device configured to execute the instructions from the memory.

10. The information processing system of claim 9 further comprising storage storing the social graph.

11. The information processing system of claim 9 wherein the memory further comprises instructions for:
determining the strength of connectedness according to at least one of: frequency, duration, recency, and origin of the call/text transactions.

12. The information processing system of claim 9 wherein the memory further comprises instructions for: grouping by at least one of: type of transaction, time of day, and recurrence.

13. The information processing system of claim 9 wherein the memory further comprises instructions for: eliminating the call/text transactions to/from a business from the social graph.

14. The information processing system of claim 9 wherein receiving the user's call logs comprises steps of:
determining the service provider;
verifying that the user has provided permission to access the call logs; and
requesting the call logs from the service provider.

15. The information processing system of claim 14 wherein the memory further comprises instructions for:
syncing with the mobile device;
searching contacts in the mobile device; and
matching numbers from the call logs to the contacts in the mobile device.

16. The information processing system of claim 9 wherein the memory further comprises instructions for merging the ranked social pairs by:
viewing social connection sites to which the user belongs;
determining if any of the call/text social partners are already members of the social connection sites;
sending a request to the call/text social partner to join the user's social connection site when it is determined that the call/text social partner is not already a member; and
updating the user's social profile when the call/text social partner joins the user's social connection site.

17. A computer program product comprising a computer-readable storage medium with program instructions stored therein, said program instructions, when executed by a processing device, causing a computer to perform:
receiving a user's call logs with call/text transactions for a mobile device;
deriving usage information from the call logs to determine social pairs, wherein a social pair comprises the user plus a call/text social partner;
ranking the social pairs based on strength of connectedness to generate a social graph; and
merging the ranked social pairs with the user's contacts from on-line social networks.

18. The computer program product of claim 17 further comprising instructions for:
determining the strength of connectedness according to at least one of: frequency, duration, recency, and origin of the call/text transactions.

19. The computer program product of claim 17 wherein deriving the usage information further comprising instructions for:
determining the service provider;
verifying that the user has provided permission to access the call logs;
requesting the call logs from the service provider;
syncing with the mobile device;
searching contacts in the mobile device; and
matching numbers from the call logs to the contacts in the mobile device.

20. The computer program product of claim 17 wherein deriving the usage information further comprising instructions for merging the ranked social pairs by:
viewing social connection sites to which the user belongs;
determining if any of the call/text social partners are already members of the social connection sites;
sending a request to the call/text social partner to join the user's social connection site when it is determined that the call/text social partner is not already a member; and
updating the user's social profile when the call/text social partner joins the user's social connection site.
